(19) United States
(12) Patent Application Publication
(10) Pub. No.: US 2014/0001181 A1
(43) Pub. Date: Jan. 2, 2014

(54) UV-Cured Strengthening Coating For Glass Containers

(71) Applicants: Pramod K. Sharma, Ann Arbor, MI (US); Carol A. Click, Corning, NY (US)

(72) Inventors: Pramod K. Sharma, Ann Arbor, MI (US); Carol A. Click, Corning, NY (US)

(21) Appl. No.: 13/539,822

(22) Filed: Jul. 2, 2012

(51) Int. Cl. B05D 3/06; B65D 25/34

(52) U.S. Cl. 220/62.15; 427/515

(57) ABSTRACT

A glass container and related methods of manufacturing and coating glass containers. The glass container includes an inorganic-organic hybrid coating over at least a portion of an exterior surface of a glass substrate.

The present disclosure is directed to glass containers, and coating processes for glass containers including methods and materials for coating glass containers (e.g., glass bottles and jars).

### BACKGROUND AND SUMMARY OF THE DISCLOSURE

Various processes have been developed to apply coatings to glass containers for different purposes, including glass strengthening for damage prevention and fragment retention. For example, U.S. Pat. No. 3,522,075 discloses a process for coating a glass container in which the glass container is formed, coated with a layer of metal oxide such as tin oxide, cooled through a lehr, and then coated with an organopolysiloxane resin-based material over the metal oxide layer. In another example, U.S. Pat. No. 3,853,673 discloses a method of strengthening a glass article by, for example, applying to a surface of the article a clear solution of a soluble, further hydrolyzable metallosiloxane, and maintaining the glass article at an elevated temperature sufficiently high to convert the metallosiloxane to a heat-treated polymetallosiloxane gel structure. In a further example, U.S. Pat. No. 3,912,100 discloses a method of making a glass container by heating the glass container and applying a polyurethane powder spray to the glass container.

A general object of the present disclosure is to provide an improved method of applying, to a glass container, a coating that strengthens the underlying glass.

The present disclosure embodies a number of aspects that can be implemented separately from or in combination with each other.

A method of applying an inorganic-organic hybrid coating to a glass container may include the steps of (a) providing a glass substrate that defines a shape of the glass container and (b) forming an inorganic-organic hybrid coating over an exterior surface of the glass substrate. The inorganic-organic hybrid coating comprises an inorganic polymer component and an organic polymer component. The step of forming the inorganic-organic hybrid coating may include (b1) applying a coating composition over the exterior surface of the glass substrate and (b2) exposing the coating composition to UV light for a time sufficient to cure the coating composition. The coating composition may include a UV curable organofunctional silane that includes an alkoxy functional group and an acrylic ester functional group, colloidal silica, water, a catalyst, and an organic solvent.

In accordance with another aspect of the disclosure, there is provided a method of applying an inorganic-organic hybrid coating to a glass container. The method may include the steps of (a) providing a glass container that includes a soda-lime glass substrate that defines a shape of the container; (b) applying a coating composition over an exterior surface of the glass substrate; and (c) exposing the coating composition to UV light for a time sufficient to cure the coating composition. The coating composition applied in step (b) may comprise (1) a UV curable organofunctional silane that includes an alkoxy functional group and an acrylic ester functional group, (2) colloidal silica, (3) water, (4) a catalyst, and (5) an organic solvent. A photoinitiator and a non-silane monomer or polymer that includes an acryl functional group or an epoxide functional group may be excluded from the coating composition.

In accordance with yet another aspect of the disclosure, there is provided a method of applying an inorganic-organic hybrid coating to a glass container. The method may include the steps of (a) providing a glass container that defines a shape of the container and (b) forming an inorganic-organic hybrid coating over an exterior surface of the glass substrate. The inorganic-organic hybrid coating comprises an inorganic polymer component and an organic polymer component. The step of forming the inorganic-organic hybrid coating may include (b1) applying a coating composition over the exterior surface of the glass substrate and (b2) exposing the coating composition to UV light for a time sufficient to cure the coating composition. The coating composition may include a UV curable organofunctional silane that includes an alkoxy functional group and an acrylic ester functional group, water, a catalyst, and an organic solvent. The UV curable organofunctional silane, moreover, comprises a first organofunctional silane compound and a second organofunctional silane compound.

In accordance with an additional aspect of the disclosure, there is provided a glass container that may include an axially closed base at an axial end of the glass container, a body extending axially from the base and being circumferentially closed, and an axially open mouth at another end of the glass container opposite of the base. The glass container may also include an inorganic-organic hybrid coating over an exterior surface of the glass substrate. The inorganic-organic hybrid coating may comprise an inorganic polysiloxane polymer component and an organic polyacrylic polymer component.

### BRIEF DESCRIPTION OF THE DRAWINGS

The disclosure, together with additional objects, features, advantages and aspects thereof, will be best understood from the following description, the appended claims and the accompanying drawings, in which:

FIG. 1 is an elevational view of a glass container in accordance with an exemplary embodiment of the present disclosure;

FIG. 2 is a cross-sectional view of the glass container body before coating;

FIG. 3 is an enlarged sectional view of the glass container, taken from circle 3 of FIG. 1;

FIG. 3A is a sectional view of a glass container according to another embodiment;

FIG. 3B is a sectional view of a glass container according to a further embodiment; and

FIG. 4 is a flow diagram that illustrates a method of applying an inorganic-organic hybrid coating to a glass container.

### DETAILED DESCRIPTION OF PREFERRED EMBODIMENTS

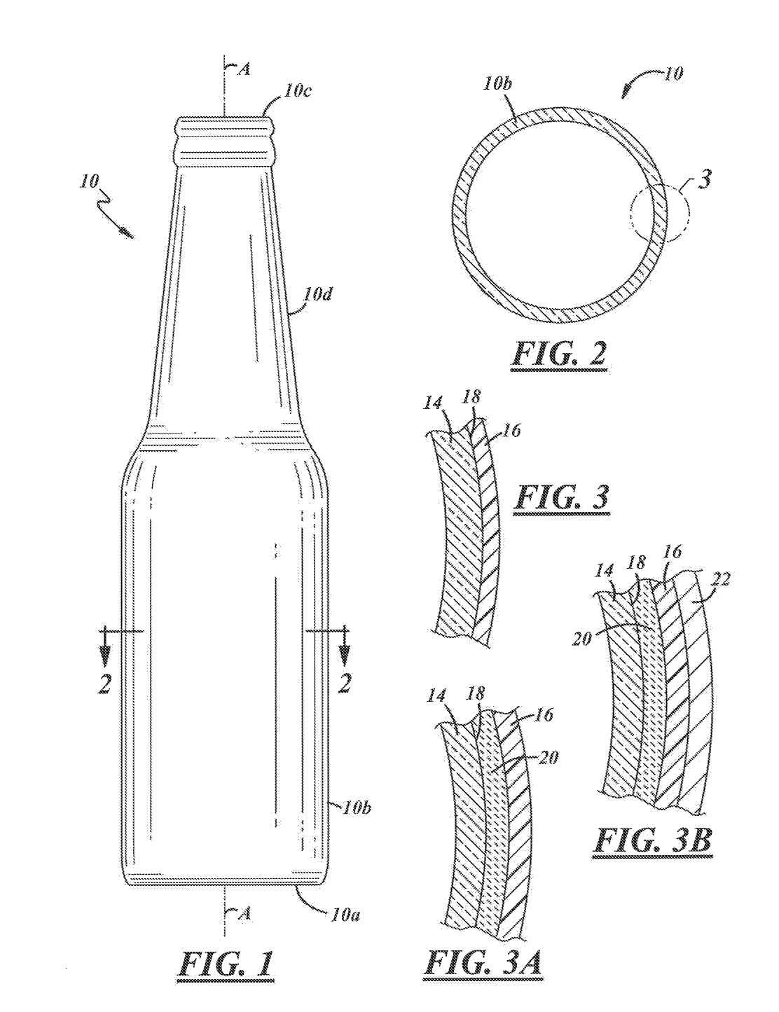

FIG. 1 illustrates an exemplary embodiment of a glass container 10 that may be produced in accord with an exemplary embodiment of a manufacturing process presently disclosed hereinbelow. The glass container 10 includes a longitudinal axis A, a base 10a at one axial end of the container 10 that is closed in an axial direction, a body 10b extending in an axial direction from the axially closed base 10a, and a mouth 10c at another axial end of the container 10 opposite of the base 10a. Accordingly, the glass container 10 is hollow. In the illustrated embodiment, the container 10 also includes a neck 10d that may extend axially from the body 10b, may be generally conical in shape, and may terminate in the mouth 10c. However, the container 10 need not include the neck 10d and the mouth 10c may terminate the body 10b, such as in a glass jar embodiment or the like. The body 10b may be of any suitable shape in cross-section transverse to the axis A as long as the body 10b is circumferentially closed.

As shown in FIG. 2, for example, the body 10b may be of cylindrical transverse cross-sectional shape that is circumferentially closed. In other embodiments, the body 10b may be generally oval, square, rectangular, or of any other suitable transverse cross-sectional shape. As used herein, the term “circumferentially” applies not only to circular or cylindrical transverse cross-sectional shapes but also applies to any transverse cross-sectional shape.

The glass container 10, as shown best in FIGS. 3-3B, includes a glass substrate 14 that defines its shape. The glass substrate 14 is preferably comprised of soda-lime glass. This type of glass is comprised primarily of silica (SiO₂) with soda (Na₂O) and lime (CaO) being the other major constituents. A typical soda-lime glass composition may include, for example, about 60 wt. % to about 75 wt. % silica, about 12 wt. % to about 18 wt. % soda, and about 5 wt. % to about 12 wt. % lime. Smaller amounts of additives may also be included in soda-lime glass. These additives usually include one or more of the following: about 0-2 wt. % alumina (Al₂O₃), about 0-4 wt. % magnesia (MgO), about 0-1.5 wt. % potash (K₂O), about 0-1 wt. % iron oxide (Fe₂O₃), about 0-0.5 wt. % titanium oxide (TiO₂), and about 0-0.5 wt. % sulfur trioxide (SO₃). Other alternative glass compositions known to skilled artisans may of course be used to make the glass substrate 14 besides soda-lime glass. A few examples of other suitable glass compositions include borosilicate glass, quartz, or any other type of glass that exhibits a refractive index greater than or equal to 1.50.

An inorganic-organic hybrid coating 16 may be disposed over an exterior surface 18 of the glass substrate 14. The inorganic-organic hybrid coating 16 may be directly applied to the exterior surface 18 of the glass substrate 14 as shown in FIG. 3. In other embodiments, however, the inorganic-organic hybrid coating 16 may be applied over another, different coating already present on the glass substrate 14. For example, as shown in FIG. 3A, the inorganic-organic hybrid coating 16 may be applied to a hot-end coating 20 that has been deposited onto the exterior surface 18 after formation of the glass substrate 14 but before annealing. The hot-end coating 20 may comprise tin oxide or any other suitable material(s). As such, application of the inorganic-organic hybrid coating 16 over the exterior surface 18 encompasses direct application to the exterior surface 18 as well as the application to one or more coatings that are already present (i.e., situated radially inward of the coating 16) on the exterior surface 18. One or more coatings may also be applied over (i.e., radially outward of) the inorganic-organic hybrid coating 16 if warranted. For example, as shown in FIG. 3B, a cold-end coating 22 may be applied over the inorganic-organic hybrid coating 16 anytime after the glass substrate 14 has been annealed. The cold-end coating 22 may comprise polyethylene wax or any other suitable material(s).

The inorganic-organic hybrid coating 16 may be a transparent film material that contains a polysiloxane inorganic polymer component and a polyacrylic organic polymer component. These inorganic and organic polymer components are bonded together within the same polymer network and can molecularly interact with one another to synergistically provide the coating 16 with desirable properties. Merging the properties typically associated with inorganic and organic polymers, for instance, can furnish the inorganic-organic hybrid coating 16 with a high optical transparency, excellent abrasion and impact resistance, a relatively high thermal stability, sufficient hardness and flexibility, and/or a suitable adhesiveness. The inorganic-organic hybrid coating 16 can thus contribute to the enhancement of one or more properties of the underlying glass substrate 14 when applied over the exterior surface 18. Most notably, the inorganic-organic hybrid coating 16 may strengthen the glass substrate 14.

The inorganic-organic hybrid coating 16 may be the UV cured reaction product of a coating composition that comprises a UV curable organofunctional silane. Other substances may also be included in the coating composition to help facilitate inorganic and organic polymerization of the UV curable organofunctional silane during formation of the inorganic-organic hybrid coating 16. For example, in addition to the UV curable organofunctional silane, the coating composition may further include colloidal silica, water, a catalyst, and an organic solvent. The coating composition, moreover, preferably does not include a photoinitiator or any polymerizable non-silane organic compounds—although the exclusion of such compounds is not mandatory in all instances. A non-silane organic compound is any organic monomer or polymer considered not to be a silane due to the absence of a silicon atom that supports one or more functional groups. Non-silane monomers and polymers that include an acryl functional group or an epoxide functional group (i.e. acrylates, methacrylates, and polyepoxide resins) are a few particular polymerizable non-silane organic compounds that are preferably excluded from the coating composition.

The UV curable organofunctional silane may be a silane compound that includes at least two different functional groups. One of those functional groups may be an alkoxy functional group (—OR) and the other may be an acrylic ester functional group (—OCOCCH₂R). Each of those groups is polymerizable. The alkoxy functional group, more specifically, can undergo hydrolytic polycondensation with the alkoxy functional groups of other organofunctional silane compounds and with the surface hydroxide groups of the colloidal silica, if present, to form an inorganic polysiloxane polymer component (i.e., Si—O—Si linkages between organofunctional silane compounds and/or colloidal silica). The acrylic ester functional group, on the other hand, can undergo addition polymerization with other acrylic ester functional groups to form an organic polyacrylic polymer component (i.e., C—C linkages between organofunctional silane compounds). A photoinitiator is not necessarily required to initiate such addition polymerization because the acrylic ester functional groups can self-initiate—that is, they can experience bond cleavages that result in free radicals—when exposed to UV light. The inorganic polysiloxane and the organic polyacrylic components produced by the polymerization of the organofunctional silane can form a hybrid polymer network in which the inorganic and organic polymer components molecularly interact with one another—both intermolecularly and intramolecularly—to provide the coating 16 with its desired properties. The UV curable organofunctional silane may include a single silane compound or several different types of silane compounds.

In a preferred embodiment, the alkoxy functional group is a methoxy or ethoxy group, and the acrylic ester functional group is an acryloxy group or a methacryloxy group. A specific example of a suitable UV curable organo functional silane is methacryloxypropyltrimethoxysilane (MAPTMS). The chemical structure of MAPTMS is shown below. As shown, MAPTMS includes three methoxy groups and one methacryloxy group. MAPTMS is commercially available from a variety of companies including Gelest, Inc. (headquartered in Morrisville, Pa.). Other UV curable organofunctional silanes that may be employed include acryloxypropyltrimethoxysilane and dimethoxyacryloxypropyl-dimethoxysilane. The chemical structure of each of these organofunctional silanes is also shown below.

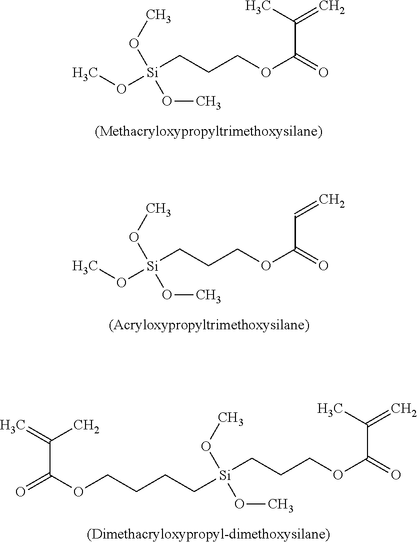

The colloidal silica may be optionally present in the coating composition for any suitable reasons such as, for example, to supplement the inorganic polysiloxane polymer component. The colloidal silica may be a dispersion of submicron-sized silica (SiO₂) particles in a liquid medium. The silica particles have particle sizes defining their largest dimensions that range from about 1 nm to about 200 nm, more preferably from about 5 nm to about 100 nm, and most preferably from about 5 nm to about 50 nm. The liquid medium in which the silica particles are dispersed can assume a variety of environments. The liquid may be aqueous or organic and its pH may range from acidic to alkaline. A typical liquid medium may be comprised of water, an aliphatic alcohol, or a blend of water and an aliphatic alcohol, with an acid or salt typically being added to promote acidity or alkalinity, respectively. A pH of the liquid medium that ranges anywhere from about 2.0 to about 9.0 may be suitable. The silica particle content of the colloidal silica may range from about 20 wt. % to about 50 wt. %, based on the weight of both the silica particles and the liquid medium, depending on various considerations including the size of the silica particles. A suitable colloidal silica for use in the preparing the coating composition can be obtained commercially from BYK-Chemie (headquartered in Wesel, Germany).

The UV curable organofunctional silane and the colloidal silica, if present, may be physically mixed or chemically affiliated, or both, when initially introduced into the coating composition. Physical mixing is present when the UV curable organofunctional silane and the colloidal silica are mixed together, but are not chemically bonded to each other. Chemical affiliation is present when the silica particles of the colloidal silica are functionalized with the UV curable organofunctional silane through conventional grafting reactions. Such grafting results in UV curable organofunctional silane compounds being chemically bonded to the surfaces of the silica particles through siloxane bonds formed at the alkoxy functional group location. The acrylic ester functional groups remain more distally located relative to the silica particles.

The coating composition may include water, the catalyst, and the organic solvent to help facilitate inorganic and organic polymerization of the UV curable organofunctional silane, as previously mentioned. The water may be added to induce hydrolysis of the alkoxy functional group to form an intermediate reactive group, typically a hydroxide, capable of participating in a polycondensation reaction. The catalyst may be added to promote at least one, and preferably both, of the hydrolysis of the alkoxy functional group and the polycondensation of the intermediate group to ultimately form the inorganic polysiloxane polymer component. A preferred catalyst is an acid such as, for example, glacial acetic acid, hydrochloric acid, sulfuric acid, nitric acid, and combinations thereof. And finally, the organic solvent may be added to provide a compatible liquid which allows the coating composition to achieve and maintain a homogeneously mixed state when originally prepared. A preferred organic solvent is a C1-C6 aliphatic alcohol such as methanol, ethanol, n-propanol, isopropanol, butanol, and combinations thereof.

The coating composition may be formulated so that the inorganic-organic hybrid coating 16 exhibits a glass strengthening facility. The robust properties of the inorganic-organic hybrid coating 16—most notably its hardness, flexibility, and abrasion and impact resistance—may allow the coating 16 to heal surface anomalies, reinforce structural flaws in the glass substrate 14, and prevent the further creation of such defects. Cracks, chips, inclusions, internally stressed glass regions, and any other sites of weakness in the glass substrate 14 can be covered and, if pertinent, filled by the inorganic-organic hybrid coating 16. And since it is relatively flexible, the inorganic-organic hybrid coating 16 has some ability to inhabitate and support such sites of weakness and to spread the strain involved throughout the coating 16 as opposed to suffering localized fracturing. When applied over the exterior surface 18 of the glass substrate 14, the practical strengthening effect manifested by the inorganic-organic hybrid coating 16 may be an enhanced burst strength and fracture retention capability of the glass container 10 as a whole.

The inorganic-organic hybrid coating 16 may exhibit a suitable glass strengthening effect when, for example, the coating composition comprises, by weight percent based on the total weight of the coating composition, about 1.0% to about 50.0% of the UV curable organofunctional silane. In one particular exemplary embodiment, in which colloidal silica is present, the coating composition may comprise, by weight based on the total weight of the coating composition, about 1.0% to about 6.0% of the organofunctional silane, about 1.0% to about 6.0% of the colloidal silica, about 0.10% to about 5.0% water, about 1.0% to about 10% of the catalyst, and about 75% to about 98% of the organic solvent. In another exemplary embodiment, in which colloidal silica is not present, although the exclusion of colloidal silica is not mandatory, the coating composition may comprise, by weight based on the total weight of the coating composition, about 10% to about 50% of the UV curable organofunctional silane, in which a first organofunctional silane compounds such as MAPTMS and a second organofunctional silane compound such as DMAPDMS are used, about 5% to about 15% water, about 0.1% to about 10% of the catalyst, and about 30% to about 90% of the organic solvent.

The thickness of the inorganic-organic hybrid coating 16 may range from about 100 nm to about 1000 nm. The inorganic-organic hybrid coating 16 may be applied with a greater thickness if either or both of the hot-end coating 20 and the cold-end coating 22 are omitted. The inorganic-inorganic hybrid coating 16 may further vary in thickness to some extent over the glass substrate 14 despite the fact that the various coatings 16, 20, 22 are shown in FIGS. 3-3B as discrete idealized layers overlying one another sequentially. For instance, variances in the surface morphology of the exterior surface 18 of the glass substrate 14 and the hot-end and cold-end coatings 20, 22, if present, may contribute to some natural inconsistency in the thickness of the inorganic-organic hybrid coating 16 on the nanometer level. The inorganic-organic hybrid coating 16 and the hot-end and/or cold-end coatings 20, 22 may also penetrate each other along their interfaces to form an assimilated transition region of minimal, yet variable, thickness.

The inorganic-organic hybrid coating 16 may be monolithic or it may be layered. The inorganic-organic hybrid coating 16 is considered “monolithic” if the coating 16 has a generally consistent composition across its thickness and if the entire coating 16 is cured at the same time by exposure to UV light. Producing the inorganic-organic hybrid coating 16 in this way may provide the coating 16 with a thickness that ranges from about 100 nm to about 200 nm—preferably about 130 nm. The inorganic-organic hybrid coating 16 is considered “layered,” on the other hand, if the coating 16 is made by applying and curing two or more layers of the coating composition such that each of the layers is cured separately from one another and in succession. Each of the successively applied and cured layers may have a thickness that ranges from about 100 nm to about 200 nm. Anywhere from two to five of the individually cured layers are preferably stacked to produce the inorganic-organic hybrid coating 16 with a thickness that lies anywhere between about 200 nm and about 1000 nm.

The inorganic-organic hybrid coating 16 may be more functionally robust than other types of coatings for glass containers such as, for example, a conventional inorganic SiO₂-based coating. Such an inorganic SiO₂-based coating may require exposure to high temperatures to cure, and further may not have the capability to improve the strength of the underlying glass substrate 14 to the same extent as the inorganic-organic hybrid coating 16. This is because the conventional inorganic SiO₂-based coating may be unable to exhibit the same balance of hardness, flexibility, abrasion resistance, and impact resistance that may be exhibited by the inorganic-organic hybrid coating 16 when fully cured. For this reason, at least in part, the conventional inorganic SiO₂-based coating may need to be paired with fragment retention coating to achieve the same glass strengthening effect as the inorganic-organic hybrid coating 16. Fragment retention coatings of this kind are typically polyurethane-based and formed from an isocyanate and a diol of bisphenol A, melamine, and/or benzoguanamine. But these types of coatings are expensive to prepare and add complexity to the overall glass container manufacturing process. The inorganic-organic hybrid coating 16 may therefore be the better candidate when, in addition to improving the clarity of the glass substrate 14, the thickness of the glass substrate 14 is also sought to be reduced in the simplest way.

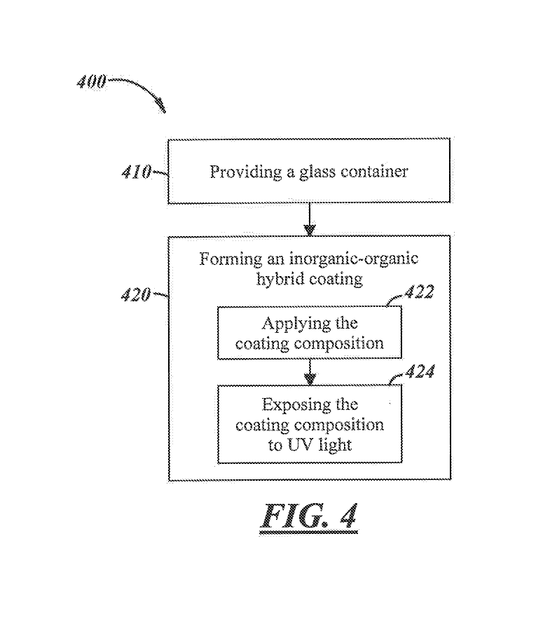

Referring now to FIG. 4, a method 400 of applying the inorganic-organic hybrid coating 16 to the glass container 10 is illustrated generally with a flow diagram. The method may include some or all of the following steps: (a) providing the glass container 10 defined by the glass substrate 14 (step 410); and (b) forming the inorganic-organic hybrid coating 16 over the exterior surface 18 of the glass substrate (step 420). The step of forming the inorganic-organic hybrid coating 16 may include (b1) applying the coating composition over the exterior surface 18 of the glass substrate 14 (step 422); and (b2) exposing the coating composition to UV light for a time sufficient to cure the coating composition (step 424). Other steps may also be performed during practice of this method even though such additional steps are not explicitly recited here. Skilled artisans will know and understand which additional steps may be practiced and how those other steps should be carried out in accordance with the method graphically illustrated in FIG. 4.

The glass container 10 may be provided, for example, by forming the glass substrate 14 into any desirable shape in accordance with a typical glass blowing procedure. This procedure involves receiving a glass raw material recipe (i.e., the batch) at a “hot-end” portion of the operation. The hot-end portion is where the batch is melted and initially formed into the glass container 10 albeit in pre-conditioned state. One or more furnaces, one or more forming machines, and all or part of one or more annealing lehrs are usually encompassed by the hot-end portion as is generally known by skilled artisans. The furnace(s) preferably heats the batch to between about 1300° C. and about 1600° C. to produce a glass melt. The forming machine(s) cuts gobs of the glass melt at a slightly lower temperature, but still high enough to accommodate plastic deformation, usually about 1050° C. to about 1200° C., and then fashions the gobs into the glass container 10. Once formed, the glass container 10 is briefly cooled to preserve its shape, and then re-heated to about 550° C. to about 750° C. in the annealing lehr(s) and cooled slowly to remove stress points that may have developed in the glass substrate 14. The hot-end coating 20, if applied, may be deposited onto the exterior surface 18 of the glass substrate 14 by any suitable technique before the container 10 enters the annealing lehr(s).

The formed glass container 10 is then received at a “cold-end” portion of the operation. The cold-end portion is where the final cooling of the container 10 occurs, usually between about 40° C. to about 130° C., as well as inspection (visually or by automated optical equipment) and packaging. The final downstream cooling segments of the annealing lehrs and the various inspection and packaging equipment pieces are typically encompassed by the cold-end portion as is generally known to skilled artisans. Then, after progressing through the cold-end portion, the container 10 may be subjected to any additional processing that may be required, and eventually packaged. The cold-end coating 22, if applied, may be deposited over the inorganic-organic hybrid coating 16 by any suitable technique after the container 10 exits the annealing lehr(s).

The coating composition may be applied over the exterior surface 18 of the glass substrate 14 at any time after the glass container 10 has emerged from the hot-end portion of the operation—preferably when the glass substrate 14 has reached at a temperature at or below about 100° C. Any suitable technique may be used to apply the coating composition including spraying, brushing, dip coating, spin coating, and curtain coating. The applied coating composition is then exposed to UV light for a period of time sufficient to cure the coating composition. Any source of UV light may be used including black lights, ultraviolet fluorescent lamps, gas-discharge lamps, ultraviolet LEDs, and/or any other suitable source. The UV light may have a wavelength on the electromagnetic spectrum that ranges from about 50 nm to about 600 nm, more preferably about 300 nm to about 450 nm, and most preferably about 350 nm to about 450 nm. And depending on the specific wavelength of the UV light, the coating composition typically takes between about 10 seconds and 5 minutes to densify and fully cure, with shorter UV light wavelengths generally achieving shorter curing times. When UV light having the most preferred wavelength from about 180 nm to about 260 nm is utilized, for example, the coating composition may be exposed to the UV light for about 60 seconds to effectuate curing. The application of the coating composition and its curing with UV light may be performed once—which renders the inorganic-organic hybrid coating 16 monolithic—or it may be repeated several times in succession—which renders the inorganic-organic hybrid coating 16 layered. Applying the coating composition and curing it, then repeating the process anywhere from two to five times in succession, may improve the strength of the underlying glass substrate 14 to a greater extent than if the coating 16 is applied in monolithic form.

The formation of the inorganic-organic hybrid coating 16 from the coating composition through UV light exposure is quick, simple, and consumes less energy than the formation other types of coatings for glass containers including the conventional inorganic SiO₂-based coating described before. Each of these efficiencies can be realized because the glass container 10 does not have to be subjected to another heat treatment after exiting the annealing lehr(s) in order to thermally cure the coating composition—exposure UV light is sufficient here. In other words, after the coating composition is applied, the container 10 does not have to be re-circulated back through the annealing lehr(s) or conveyed through a separate oven, lehr, and/or furnace to thermally cure the coating composition and derive the inorganic-organic hybrid coating 16. The coating composition can be cured sufficiently by exposure to UV light and does not have to be heated to temperatures above 100° C. after application to the glass substrate 14.

Conversely, the conventional inorganic SiO₂-based coating is usually synthesized from a traditional sol-gel method that includes application to the intended glass substrate followed by thermal curing. The process equipment needed to invoke such thermal curing may include a drying oven (to dry the sol-gel solution into a gel) and a high-temperature furnace (to thermally derive the final hardened coating from the viscous gel). The temperature needed to effectuate full thermal curing in the high-temperature furnace is often about 450° C. to about 550° C. But these heating requirements, especially those associated with the high-temperature furnace, may consume significant process time and energy. The ability to devote less relatively less time and energy to formation of the inorganic-organic hybrid coating 16 because of its receptiveness to UV curing is therefore a welcome contribution the art of glass manufacturing.

### EXAMPLES

Below, and with reference to Tables 1-2, several examples of an inorganic-organic hybrid coating and their preparation are provided and explained, as well as a coating technique and performance results.

TABLE 1

| | | Colloidal | N-Pro- | | | Total |
|---|---|---|---|---|---|---|
| Exam- | Silane | Silica Sus- | panol | Acetic | Water | solution |
| ples | (gm) | pension (gm) | (gm) | Acid(gm) | (gm) | (gm) |
| #1 | 0.26 | 1.00 | 23.45 | 0.26 | 0.03 | 25.00 |
| #2 | 0.26 | 1.00 | 23.45 | 0.26 | 0.03 | 25.00 |
| #3 | 0.26 | 1.00 | 23.45 | 0.26 | 0.03 | 25.00 |

### Example 1

### Coating Composition Preparation

A solution was prepared from 23.45 g of n-propanol, 0.26 g of acetic acid, 0.03 g of water, 0.26 g of MAPTMS, and 1.0 gm of colloidal silica. The solution was then stirred for 1 hour. The n-propanol and the acetic acid were obtained from Fisher Scientific, the MAPTMS was obtained from Gelest, Inc., and the colloidal silica was obtained from BYK-Chemie (BYK-LP X 20470).

Formation of an Inorganic-Organic Hybrid Coating

The coating composition was spin-coated at 1200 rpm onto the surface of a glass substrate that had a 2 inch by 2 inch surface area and a thickness of 3.3 mm. The coating was then cured by UV light for about 30 seconds with an electrodeless “D bulb” obtained from Fusion UV Systems (Gaithersburg, Md.) to form an inorganic-organic hybrid coating. The electrodeless “D bulb” had a UV light output spectra primarily between about 350 nm and about 450 nm. After curing, the inorganic-organic hybrid coating had a thickness of about 130 nm.

In this Example, moreover, a crack was formed on the glass substrate before application of the coating composition. The crack was formed by a Vickers hardness instrument operated at 25 gf for 30 seconds.

Glass Strengthening Performance of the Organic-Inorganic Hybrid Coating

The inorganic-organic hybrid coating was analyzed by optical microscopy to analyze the healing effect on the crack. Micrographs of the crack were taken before and after the inorganic-organic hybrid coating was applied. The micrographs indicated that the crack was at least partially filled by the inorganic-organic hybrid coating in a manner that would suggest an improvement in strength of the glass substrate.

### Example 2

### Coating Composition Preparation

A solution was prepared in the same way as Example 1.

Formation of an Inorganic-Organic Hybrid Coating

The coating composition was spin-coated at 1200 rpm three times onto the surface of a glass substrate that had a 2 inch by 2 inch surface area and a thickness of 3.3 mm. The coating composition was cured each time it was applied, and prior to the application of the next layer, by UV light for about 30 seconds with an electrodeless “D bulb” obtained from Fusion UV Systems (Gaithersburg, Md.) to form, together, an inorganic-organic hybrid coating. The electrodeless “D bulb” had a UV light output spectra primarily between about 350 nm and about 450 nm. Each application and curing of the coating composition provided a layer about 130 nm thick such that the final, layered inorganic-organic hybrid coating had a thickness of about 390 nm. And just like in Example 1, a crack was formed on the glass substrate before the applications of the coating composition as previously described.

Glass Strengthening Performance of the Organic-Inorganic Hybrid Coating

The inorganic-organic hybrid coating was analyzed by optical microscopy to analyze the healing effect on the crack. Micrographs of the crack were taken before and after the inorganic-organic hybrid coating was applied. The micrographs indicated that the crack was at least partially filled by the inorganic-organic hybrid coating in a manner that would suggest an improvement in strength of the glass substrate. The crack formed on the glass substrate in this Example appeared to be filled, and thus healed, to a greater extent than the crack in Example 1.

### Example 3

### Coating Composition Preparation

A solution was prepared in the same way as Example 1.

Formation of an Inorganic-Organic Hybrid Coating

The coating composition was spin-coated at 1200 rpm five times onto the surface of a glass substrate that had a 2 inch by 2 inch surface area and a thickness of 3.3 mm. The coating composition was cured each time it was applied, and prior to the application of the next layer, by UV light for about 30 seconds with an electrodeless “D bulb” obtained from Fusion UV Systems (Gaithersburg, Md.) to form, together, an inorganic-organic hybrid coating. The electrodeless “D bulb” had a UV light output spectra primarily between about 350 nm and about 450 nm. Each application and curing of the coating composition provided a layer about 130 nm thick such that the final, layered inorganic-organic hybrid coating had a thickness of about 650 nm. And just like in Example 1, a crack was formed on the glass substrate before the applications of the coating composition as previously described.

Glass Strengthening Performance of the Organic-Inorganic Hybrid Coating

The inorganic-organic hybrid coating was analyzed by optical microscopy to analyze the healing effect on the crack. Micrographs of the crack were taken before and after the inorganic-organic hybrid coating was applied. The micrographs indicated that the crack was at least partially filled by the inorganic-organic hybrid coating in a manner that would suggest an improvement in strength of the glass substrate. The crack formed on the glass substrate in this Example appeared to be filled, and thus healed, similar to crack in Example 2.

### Example 4

### Coating Composition Preparation

A first solution was prepared from 13.84 g of absolute ethanol, 0.15 g of 37.1% hydrochloric acid, and 8.1 g of water. A second solution was prepared from 13.79 g of absolute ethanol and 27.04 g of MAPTMS. Each of the first and second solutions was stirred for 15 minutes. The second solution was then added to the first solution very slowly under continuous magnetic stirring. The container that held the resultant mixed solution was covered with Parafilm foil and constant stirring was maintained. The MAPTMS was obtained from the same source previously mentioned.

A third solution was also prepared from 9.21 g of absolute ethanol and 7.64 g of dimethacryloxypropyl-dimethoxysilan (DMAPDMS). The DMAPDMS was obtained from Gelest Inc. The third solution was stirred for 15 minutes and, after three hours of stirring the mixed solution (the first and second solutions), was added dropwise to the mixed solution over the course of three hours while stirring was maintained. The final mixed solution (first, second, and third solutions) was stirred in a closed system for another two hours at which time 2.78 μL of 30% ammonium hydroxide was added. The stirring was then continued for another two hours in a closed system. After another hour of stirring, the parafilm foil was removed and the stirring continued for another 24 hours.

A table listing the components of each of the first, second, and third solutions is shown below.

TABLE 3

| | First Solution | Second Solution | Third Solution |
|---|---|---|---|
| Water (gm) | 8.1 | None | None |
| 37.1% HCl (gm) | 0.15 | None | None |
| Ab. Ethanol (gm) | 13.84 | 13.79 | 9.21 |
| MAPTMS (gm) | None | 27.04 | None |
| DMAPDMS (gm) | None | None | 7.64 |

Formation of an Organic-Inorganic Hybrid Coating

The coating composition was spin coated at 1200 rpm onto the surface of a glass substrate that had a 2 inch by 2 inch surface area and a thickness of 3.3 mm. The coating was then cured by UV light for about 30 seconds with an electrodeless “D bulb” obtained from Fusion UV Systems (Gaithersburg, Md.) to form an inorganic-organic hybrid coating. The electrodeless “D bulb” has a UV light output spectra primarily between about 350 nm and about 450 nm. After curing, the inorganic-organic hybrid coating had a thickness of about 200 nm.

There thus has been disclosed methods of coating glass containers and methods of manufacturing glass containers that at least partially satisfy one or more of the objects and aims previously set forth. The disclosure has been presented in conjunction with several exemplary embodiments, and additional modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A method of applying an inorganic-organic hybrid coating to a glass container, the method comprising:
(a) providing a glass substrate that defines a shape of the glass container, the glass substrate having an exterior surface;
(b) forming an inorganic-organic hybrid coating over the exterior surface of the glass substrate, the inorganic-organic hybrid coating comprising an inorganic polymer component and an organic polymer component, and wherein forming the inorganic-organic hybrid coating comprises the steps of:
(b1) applying a coating composition over the exterior surface of the glass substrate, the coating composition comprising (1) a UV curable organofunctional silane that includes an alkoxy functional group and an acrylic ester functional group, (2) colloidal silica, (3) water, (4) a catalyst, and (5) an organic solvent; and
(b2) exposing the coating composition to UV light for a time sufficient to cure the coating composition.

2. The method set forth in claim 1 wherein the UV curable organofunctional silane is present at about 1.0 wt. % to about 6.0 wt. % and the colloidal silica is present at about 1.0 wt. % to about 6.0 wt. %, each based on the total weight of the coating composition.

3. The method set forth in claim 2 wherein the water is present at about 0.10 wt. % to about 5.0 wt. %, the catalyst is present at about 1.0 wt. % to about 10.0 wt. %, and the organic solvent is present at about 78 wt. % to about 98 wt. %, each based on the total weight of the coating composition.

4. The method set forth in claim 1 wherein the UV curable organofuctional silane includes a methoxy group and a methacryloxy group.

5. The method set forth in claim 1 wherein the UV curable organofuctional silane comprises at least one of methacryloxypropyltrimethoxysilane, acryloxypropyltrimethoxysilane, or dimethacryloxypropyl-dimethoxysilane.

6. The method set forth in claim 1 wherein the inorganic-organic hybrid coating has a thickness that ranges between about 100 nm and about 1000 nm.

7. The method set forth in claim 1 wherein the coating composition is not heated above 100° C. after being applied to the exterior surface of the glass substrate.

8. The method set forth in claim 1 wherein coating composition does not include a photoinitiator.

9. The method set forth in claim 1 wherein the coating composition does not include non-silane monomers and polymers that include an acryl or an epoxide functional group.

10. The method set forth in claim 1 wherein the coating composition does not include any polymerizable non-silane compounds.

11. The method set forth in claim 1 further comprising:
(b3) repeating steps (b1) and (b2) at least once.

12. The method set forth in claim 11 wherein steps (b1) and (b2) are performed between two and five times to form the inorganic-organic hybrid coating.

13. A glass container formed according to the method set forth in claim 1.

14. A method of applying an inorganic-organic hybrid to a glass container, the method comprising:
(a) providing a glass container that includes a soda-lime glass substrate that defines a shape of the container;
(b) applying a coating composition over an exterior surface of the glass substrate, the coating composition comprising (1) a UV curable organofunctional silane that includes an alkoxy functional group and an acrylic ester functional group, (2) colloidal silica, (3) water, (4) a catalyst, and (5) an organic solvent, and wherein the coating composition does not include a photoinitiator or a non-silane monomer or polymer that includes an acryl functional group or an epoxide functional group; and
(c) exposing the coating composition to UV light for a time sufficient to cure the coating composition.

15. The method set forth in claim 14 wherein step (a) comprises forming the glass container and annealing the glass container.

16. The method set forth in claim 14 wherein the UV curable organofunctional silane is present at about 1.0 wt. % to about 6.0 wt. %, the colloidal silica is present at about 1.0 wt. % to about 6.0 wt. %, the water is present at about 0.10 wt. % to about 5.0 wt. %, the catalyst is present at about 1.0 wt. % to about 10.0 wt. %, and the organic solvent is present at about 78 wt. % to about 98 wt. %, each based on the total weight of the coating composition.

17. The method set forth in claim 14 wherein the UV curable organofuctional silane comprises at least one of methacryloxypropyltrimethoxysilane, acryloxypropyltrimethoxysilane, or dimethacryloxypropyl-dimethoxysilane.

18. The method set forth in claim 14 wherein the catalyst is an acid.

19. The method set forth in claim 14 wherein the inorganic-organic hybrid coating has a thickness that ranges between about 100 nm and about 1000 nm.

20. The method set forth in claim 14 wherein the coating composition is not heated above 100° C. after being applied to the exterior surface of the glass substrate.

21. The method set forth in claim 14 further comprising:
(d) repeating steps (b) and (c) at least once.

22. The method set forth in claim 14 further comprising:
applying a hot-end coating to the exterior surface of the glass substrate before applying the coating composition;
forming the inorganic-organic hybrid coating by performing steps (b) and (c) at least once; and
applying a cold-end coating over the inorganic-organic hybrid coating.

23. A glass container formed according to the method set forth in claim 14.

24. A glass container that includes:
a glass substrate that defines the shape of the container and provides the container with an axially closed base at an axial end of the container, a body extending axially from the base and being circumferentially closed, and an axially open mouth at another end of the glass container opposite of the base; and
an inorganic-organic hybrid coating over an exterior surface of the glass substrate, the inorganic-organic hybrid coating comprising an inorganic polysiloxane polymer component and an organic polyacrylic polymer component.

25. The glass container set forth in claim 24 wherein the inorganic-organic hybrid coating has a thickness that ranges from about 100 nm to about 1000 nm.

26. The glass container set forth in claim 24 wherein the inorganic-organic hybrid coating comprises the UV cured reaction product of a coating composition that includes (1) a UV curable organofunctional silane that includes an alkoxy functional group and an acrylic ester functional group, (2) colloidal silica, (3) water, (4) a catalyst, and (5) an organic solvent.

27. The glass container set forth in claim 26 wherein the UV curable organofunctional silane comprises at least one of methacryloxypropyltrimethoxysilane, acryloxypropyltrimethoxysilane, or dimethacryloxypropyl-dimethoxysilane.

28. The glass container set forth in claim 26 wherein, with respect to the coating composition, the UV curable organofunctional silane is present at about 1.0 wt % to about 6.0 wt. %, the colloidal silica is present at about 1.0 wt. % to about 6.0 wt. %, the water is present at about 0.10 wt. % to about 5.0 wt. %, the catalyst is present at about 1.0 wt. % to about 10.0 wt. %, and the organic solvent is present at about 78 wt. % to about 98 wt. %, each based on the total weight of the coating composition.

29. The glass container set forth in claim 26 the coating composition does not include a photoinitiator or a non-silane monomer or polymer that includes an acryl functional group or an epoxide functional group.

30. The glass container set forth in claim 24 wherein the inorganic-organic hybrid coating is layered.

31. The glass container set forth in claim 24 further comprising a hot-end coating over the exterior surface of the glass substrate underneath the inorganic-organic hybrid coating.

32. The glass container set forth in claim 24 further comprising a cold-end coating over the inorganic-organic hybrid coating.

33. A method of applying an inorganic-organic hybrid coating to a glass container, the method comprising:
(b) providing a glass substrate that defines a shape of the glass container, the glass substrate having an exterior surface;
(b) forming an inorganic-organic hybrid coating over the exterior surface of the glass substrate, the inorganic-organic hybrid coating comprising an inorganic polymer component and an organic polymer component, and wherein forming the inorganic-organic hybrid coating comprises the steps of:
(b1) applying a coating composition over the exterior surface of the glass substrate, the coating composition comprising (1) a UV curable organofunctional silane that includes an alkoxy functional group and an acrylic ester functional group, (2) water, (3) a catalyst, and (4) an organic solvent, the UV curable organofunctional silane comprising a first organofunctional silane compound and a second organofunctional silane compound; and
(b2) exposing the coating composition to UV light for a time sufficient to cure the coating composition.

34. The method set forth in claim 33 wherein the first organofunctional silane is methacryloxypropyltrimethoxysilane, and wherein the second organofunctional silane is dimethacryloxypropyl-dimethoxysilane.

35. The method set forth in claim 33 wherein the coating composition does not include a photoinitiator or any non-silane monomers and polymers that include an acryl or an epoxide functional group, and wherein the coating composition is not heated above 100° C. after being applied to the exterior surface of the glass substrate.
